(19) United States
(12) Patent Application Publication
(10) Pub. No.: US 2010/0188224 A1
(43) Pub. Date: Jul. 29, 2010

(54) Method for searching electronic data and system thereof

(75) Inventor: Yin-Chang Liu, Taipei (TW)

Correspondence Address: REED SMITH LLP;Suite 1400, 3110 Fairview Park Drive, Falls Church, VA, 22042, US

(73) Assignee: Cheng Loong Corporation.

(21) Appl. No.: 12/320,408

(22) Filed: Jan. 26, 2009

(51) Int. Cl. G08B 13/14; H04L 9/00; H04L 9/08; G06F 17/30

(52) U.S. Cl. 340/572.1; 380/44; 713/168; 707/E17.014; 707/E17.032

(57) ABSTRACT

The invention provides a method for searching electronic data and a system thereof. The method for searching electronic data includes: obtaining identification data from an RFID tag, Generating an authentication key according to the identification data, being connected to a third-party server. The third-party server is to determine whether the authentication key is right. If the authentication key is right, a first operation is allowed to be performed on the third-party server and a destination server address is obtained. A destination server is connected according to the destination server address, such that the second operation is allowed to be performed on the destination server.

### BACKGROUND OF THE INVENTION

1. Field of the Invention

The invention relates to a method for searching electronic data and, more particularly, to a method for searching electronic data and a system thereof.

2. Description of the Related Art

In recent years, there are all kinds of electronic apparatus or food of low quality usually; such that, terminal consumers begin to pay attention to how the purchased products are produced. Therefore, product pedigree is advanced. The so-called product pedigree refers to related data of products can be automatically recorded in detail in each stage such as production, processing, or marketing to facilitate the tracking of product data. Thus after buying products, the terminal consumers can search the related data on the websites by inputting the bar-code or representative number of the products provided by manufacturers.

However, for small manufacturers, it may greatly increase production cost to maintain the system for searching the product pedigree. Further, in the whole production process, a plurality of manufacturers may cooperate in production, processing, and marketing. Finally the products are sold to consumers in markets. In the above process, each of the manufacturers needs to cooperate with each other. Production data may need to be updated, and the preceding production data may need to be searched as well. Therefore, data management in the whole process becomes very important.

The present servers for tracking product pedigree adopt the centralized method for searching data. Shipping data of the manufacturers should be centrally stored in a particular server. Thus the trade secret related to the shipping may easily be disclosed. Further, updating of the data usually traces back to the preceding procedure or stage. If the updating of the data should trace back to the initial procedure or stage, restoration of the dated data in each stage is needed. If a problem occurs anywhere, the updating of the data may break off. Further, if the functions, such as sending data, storing dated data, etc simultaneously exist in each procedure, the system design may become more complicated.

### BRIEF SUMMARY OF THE INVENTION

An object of this invention is to provide a method for searching electronic data and a system thereof to improve the disadvantages of the conventional art.

According to one aspect of the invention, the method for searching electronic data provided by the invention includes the following steps: obtaining identification data from a radio frequency identification (RFID) tag, generating an authentication key according to the identification data, being connected to a third-party server, determining if the authentication key is right on the third-party server. If the authentication key is determined to be right, a first operation is allowed to be performed on the third-party server and a destination server address is obtained. A destination server is connected according to the destination server address thus allowing a second operation to be performed on the destination server.

According to another aspect of the invention, a system for searching electronic data provided by the invention includes an RFID tag, a reader, a searching apparatus, a third-party server, and a destination server. The RFID tag is used for storing identification data. The reader obtains the identification data from the RFID tag. The searching apparatus is coupled to the reader and generates an authentication key according to the identification data. The searching apparatus is connected to the third-party server over the Internet. The third-party server determines whether the authentication key is right. If the authentication key is right, a first operation is allowed to be performed on the third-party server and a destination server address is obtained from the third-party server. The third-party server is connected to the destination server according to the destination server address thus allowing a second operation to be performed on the destination server.

The advantages of the invention are that the possibility of succeeding in updating and tracing the data back can be increased, and the risk of manually changing data can be avoided. Further, no matter where the data go, the record history can be updated from the source to satisfy the requirements of tracking and tracing. The method for searching electronic data and the system thereof can be applied in all kinds of fields and, more particularly, in tracking the pedigree and telling the true from the false.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing a system for searching electronic data according to an embodiment of the invention; and

FIG. 2 is a flowchart showing a method for searching electronic data according to an embodiment of the invention.

### DETAILED DESCRIPTION OF THE EMBODIMENTS

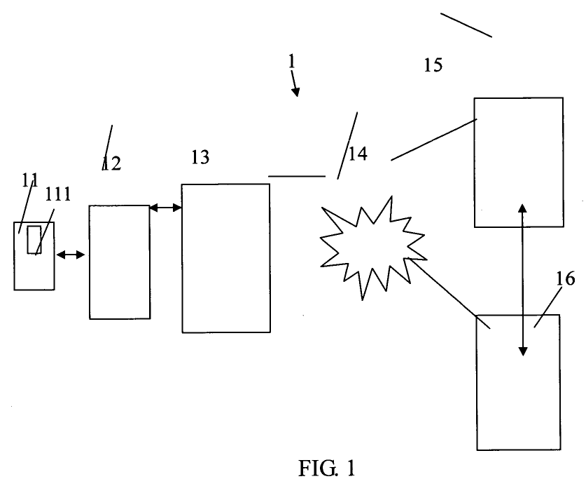

FIG. 1 is a schematic diagram showing a system for searching electronic data according to an embodiment of the invention. A system for searching electronic data 1 according to the embodiment includes an RFID tag 11, a reader 12, a searching apparatus 13, a third-party server 15, and a destination server 16.

In this embodiment, the RFID tag 11 can be disposed on or in a product. The RFID tag 11 further includes a storage unit 111 for storing identification data. In this embodiment, the identification data includes a unique identifier (UID) and pre-written data. The UID has been written thereto when manufacturers manufacture microchips, and it is unmodifiable and unique. The pre-written data is defined by manufacturers, such as a uniform resource locator (URL) or product data. The invention is not limited to the content of the identification data.

In this embodiment, the reader 12 can be disposed in a portable electronic apparatus (such as a mobile phone, a PDA, or a notebook) or in a fixed apparatus (such as a POS machine or a desktop computer), or it can be a peripheral apparatus coupled to a portable electronic apparatus or to a fixed apparatus. Further, the reader 12 is coupled to the searching apparatus 13 and sends the read data to the searching apparatus 13.

In this embodiment, the searching apparatus 13 can be a portable electronic apparatus (such as a mobile phone, a PDA, or a notebook) or a fixed apparatus (such as a POS machine or a desktop computer). The searching apparatus 13 is preferably a terminal apparatus which can be connected to the network. The terminal apparatus can be connected to the Internet 14 using a wire or a wireless mode. In this embodiment, the third-party server 15 can also be called an authentication server for storing a product code, a category code, a manufacturer name, a manufacturer code, or a URL corresponding to a manufacturer;wherein the content stored therein is not limited to the data mentioned above. In this embodiment, there can be one or more destination servers 16. For the convenience of explanation, FIG. 1 only illustrates one destination server 16. Further, both the third-party server 15 and the destination server 16 are equipped with databases to facilitate search and updating of the data.

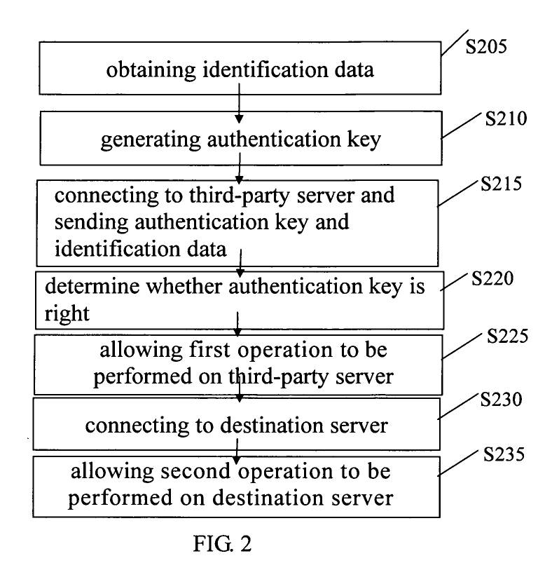

FIG. 2 is a flowchart showing a method for searching electronic data according to one embodiment of the invention. Please also refer to FIG. 1 and FIG. 2.

In step S205, to search or update product data, users can obtain the identification data in the RFID tag 11 via the reader 12. The identification data includes the UID and the pre-written data.

In step S210, the searching apparatus 13 receives the read data (identification data) from the reader 12. In this embodiment, the searching apparatus 13 can authenticate the identification data first to determine whether the identification data in the RFID tag 11 is true. Further, the searching apparatus 13 can generate an authentication key (also called a time-variant key) according to the identification data.

In step S215, the searching apparatus 13 is connected to the Internet 14, and then it is connected to the third-party server 15 over the Internet 14. Further, in this embodiment, the searching apparatus 13 also sends the authentication key, the identification data, and a source address of the searching apparatus 13 to the third-party server 15.

In step S220, after the third-party server 15 receives the authentication key from the searching apparatus 13, the third-party server 15 determines whether the authentication key is right to prevent the URL from being changed to be connected to an illegal website.

In step S225, if the authentication key is right, a first operation is allowed to be performed on the third-party server 15 and a destination server address is obtained from the third-party server 15. On the other hand, if the authentication key is wrong (failing to pass the authentication), the third-party server 15 stops the search or sends an error message to the searching apparatus 13.

In this embodiment, the first operation includes allowing users to login and providing search service. For example, the users can enter a searching menu after logging in the third-party server 15. Then they can search the URL of the manufacturer of the product related to the RFID tag 11, which is called a destination server address, by inputting product name, product serial number, manufacturer name, or other related data in the third-party server 15.

In other embodiments, the third-party server 15 can also automatically search the URL of the manufacturer of the product related to the RFID tag 11 directly according to the identification data sent from the searching apparatus 13. The first operation is not limited by the invention is not limited thereto.

In step S230, the third-party server 15 is connected to the destination server 16 according to the destination server address obtained from the above step. In the connecting process, the third-party server 15 can also send the identification data and the source address of the searching apparatus 13 received from the searching apparatus 13 to the destination server 16.

In step S235, a second operation is allowed to be performed on the destination server 16. In this embodiment, the second operation may include searching data of a product related to the RFID tag 11 or updating data of a product related to the RFID tag 11 in the destination server 16. The invention is not limited thereto. For example, users can connect to the destination server 16 using the searching apparatus 13 via the third-party server 15, and therefore the users can obtain more detailed product data from the destination server 16, such as growth and processing of a particular fruit and so on. Meanwhile, the destination server 16 can also send the related data back to the searching apparatus 13 according to the source address of the searching apparatus 13. Further, other assistant manufacturers can also directly update the data in the destination server 16 or add product pedigree information.

To sum up, the method for searching electronic data and the system thereof provided by the embodiment adopts distributed database access structure. That is, the manufacturer data is stored in the manufacture-end (such as the destination server), and the authentication party (such as the third-party server) is just for storing basic data such as the manufacturer code, the category code, and the URL. Therefore, risk of the disclosure of trade secret of the manufacturer can be reduced. Further, the data can be updated from the source, and restoration of the dated data in each stage is not needed. Thus the updating flow path can be simplified and the manual changes of the data can be avoided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for searching electronic data, comprising:
obtaining identification data from a radio frequency identification (RFID) tag;
generating an authentication key according to the identification data;
connecting to a third-party server;
determining whether the authentication key is right on the third-party server;
allowing performing a first operation on the third-party server and obtaining a destination server address if the authentication key is right; and
connecting to a destination server according to the destination server address thus allowing a second operation to be performed on the destination server.

2. The method for searching electronic data according to claim 1, wherein the identification data comprises a unique identifier (UID) and pre-written data.

3. The method for searching electronic data according to claim 1, wherein the step of connecting to the third-party server further comprises sending the authentication key and the identification data to the third-party server.

4. The method for searching electronic data according to claim 1, wherein the first operation comprises: providing search service.

5. The method for searching electronic data according to claim 1, wherein the step of connecting to the destination server according to the destination server address to allow the second operation to be performed further comprises: sending the identification data to the destination server.

6. The method for searching electronic data according to claim 1, wherein the second operation comprises: providing service of searching data of a product related to the RFID tag.

7. The method for searching electronic data according to claim 1, wherein the second operation comprises: providing service of updating data of a product related to the RFID tag in the destination server.

8. A system for searching electronic data, comprising:
an RFID tag for storing identification data;
a reader obtaining the identification data from the RFID tag;
a searching apparatus coupled to the reader and generating an authentication key according to the identification data;
a third-party server, wherein the searching apparatus is connected to the third-party server over the Internet, the third-party server determines whether the authentication key is right, and if the authentication key is right, a first operation is allowed to be performed on the third-party server and a destination server address is obtained from the third-party server; and
a destination server, wherein the third-party server is connected to the destination server according to the destination server address thus allowing a second operation to be performed on the destination server.

9. The system for searching electronic data according to claim 8, wherein the identification data comprises a UID and pre-written data.

10. The system for searching electronic data according to claim 8, wherein the searching apparatus further sends the authentication key, the identification data, and a source address of the searching apparatus to the third-party server.

11. The system for searching electronic data according to claim 8, wherein the first operation comprises: providing search service by the third-party server.

12. The system for searching electronic data according to claim 8, wherein the third-party server sends the identification data to the destination server.

13. The system for searching electronic data according to claim 8, wherein the second operation comprises: providing service of searching data of a product related to the RFID tag by the destination server.

14. The system for searching electronic data according to claim 8, wherein the second operation comprises: providing service of updating data of a product related to the RFID tag in the destination server by the destination server.
